(19) United States
(12) Patent Application Publication
(10) Pub. No.: US 2025/0183935 A1
(43) Pub. Date: Jun. 5, 2025

(54) DETACHABLE ASSEMBLY AND ELECTRONIC DEVICE KIT

(71) Applicant: TILTA INC., Burbank, CA (US)

(72) Inventors: Jiawen KANG, Shenzhen (CN); Wenping ZENG, Shenzhen (CN); Kefeng ZHOU, Shenzhen (CN)

(21) Appl. No.: 18/961,900

(22) Filed: Nov. 27, 2024

(30) Foreign Application Priority Data
Nov. 30, 2023 (CN) 2023232707025

(51) Int. Cl. H04B 1/3888; A45C 11/00

(52) U.S. Cl. CPC H04B 1/3888; A45C 11/00; A45C 11/002

(57) ABSTRACT

The present disclosure provides a protective case and a detachable assembly. The detachable assembly includes a quick-release base, a trigger, a first clamping member, and a second clamping member. The first and second clamping members are oppositely disposed on the quick-release base, with respective first and second clamping parts protruding beyond the quick-release base to form a clamping space between them. When integrated with a protective case, the detachable assembly facilitates the attachment of various photographic accessories to a mobile phone, addressing users' diverse photography needs.

### CROSS-REFERENCE TO RELATED APPLICATIONS

The present application for patent claims priority to and the benefit of pending Chinese Application No. 2023232707025, filed Nov. 30, 2023, and hereby expressly incorporated by reference herein as if fully set forth below in its entirety and for all applicable purposes.

### TECHNICAL FIELD

The present disclosure pertains to the realm of electronic kits, specifically a detachable assembly for use with protective casings.

### INTRODUCTION

As mobile phone lenses continue to increase in pixel count, the photographic capabilities of contemporary mobile devices have seen significant enhancements. However, present mobile phones primarily cater to general photography needs, limiting their functionality and restricting their use in specialized photographic applications. In response, an existing technology (e.g., as described in Chinese patent application number CN202222943812.2) introduces a mobile phone case designed to accommodate photographic lenses and filters. This case features a shell for holding the mobile phone, with a camera positioning area that aligns with and expose the phone's camera. The camera positioning area protrudes from the shell's rear facing side, and at least one latching position is provided around its outer edge. An adapter ring, featuring a central through hole for the camera, is equipped with at least one latch corresponding to the latching positions on the shell, allowing it to be fixed in place. Threads on the adapter ring's inner or outer edge facilitate the attachment of lenses or filters.

While this prior art offers a case that quickly adapts to various photographic lenses and filters, enhancing the phone's photographic effect, its functionality of adapting to photographic lenses and filters is confined to the phone itself, limiting the attachment of other accessories and falling short of meeting users' diverse photography needs.

### BRIEF SUMMARY

Aspects of the present disclosure provide a detachable assembly that facilitates easy installation and removal on a protective case, enabling the expansion of diverse photographic accessories and catering to users' varied photography needs with their mobile phones.

An aspect of the present disclosure provides an electronic device kit that supports the attachment of multiple photographic accessories, fulfilling diverse photography requirements from users when using their mobile phones.

Aspects of the present disclosure provide the following technical solution:

A detachable assembly, wherein the detachable assembly includes a quick-release base, a trigger, a first clamping member, and a second clamping member. The first and second clamping members are oppositely disposed on the quick-release base, with the first and second clamping parts protruding beyond the quick-release base to form a clamping space between the first and second clamping members. The trigger, movable on the quick-release base, is connected drivingly to the first clamping member at a first end and protrudes outside as a trigger part at a second end; the first clamping member is moveably connected to the quick-release base. In this detachable assembly, manipulation of the trigger controls the movable activation of the first clamping part on the quick-release base, thereby regulating the opening or clamping of the clamping space for rapid mounting and dismounting of the assembly onto the protective case. Photography accessories can be directly affixed to or integrally formed with the detachable assembly, or they can be detachably mounted and dismounted, so when integrated with a protective case, this detachable assembly facilitates the attachment of various photographic accessories to the mobile phone, addressing users' diverse photography needs.
wherein, an installation part for photographic accessories is located on one side of the quick-release base opposite the clamping space. Based on the positioning of the installation part on the quick-release base, the protective case can be adapted to accommodate various photography accessories, catering to the diverse needs of users when capturing images with their mobile phones.
wherein both the first and second clamping members are hinged to the quick-release base, and the trigger is connected to both the first and second clamping members. Both the first clamping member and the second clamping member are hinged to the quick-release base and are operatively connected to the trigger. The trigger can simultaneously control the movement of both clamping members to open the clamping space more extensively, facilitating easier mounting and dismounting processes.
wherein the first clamping member includes a first clamping part and a first resilient part, and the second clamping member includes a second clamping part and a second resilient part. A junction between the first clamping part and the first resilient part is hinged to the quick-release base, and similarly, a junction between the second clamping part and the second resilient part is also hinged to the same quick-release base, forming the clamping space between the first and second clamping parts. An installation cavity is positioned within the base.

The quick-release base features a pressing hole leading into the installation cavity on one side, allowing one end of the trigger to pass through and form a first resisting part against one side of the first resilient part away from the installation cavity. A second resisting part, fixed on the first resisting part, resists against the second clamping part near the installation cavity. Upon activation, the trigger pushes the first resilient part away from one side of the installation cavity via the first resisting part and pushes the second clamping part towards the opposite side via the second resisting part, thereby widening the clamping space between the first and second clamping parts.
wherein a limited post is positioned within the installation cavity. A connecting part is disposed between the first resisting part and the second resisting part, forming a movable limiting hole among the first resisting part, the second resisting part, and the connecting part; the limited post traverses this movable limiting hole. During trigger activation, the movement stability is enhanced through the cooperation of the movable limiting hole and the limited post.
wherein a guiding and limiting channel is formed between the limited post and a lateral side of the installation cavity, to constrain and direct the connecting part to move. The connecting part is movably accommodated within this guiding and limiting channel. The guiding and limiting channel further bolsters the stability of the trigger in movement.
wherein the quick-release base is equipped with a first rotating groove and a second rotating groove, both extending into the installation cavity. The junction between the first clamping part and the first resilient part resides hinged within the first rotating groove, with the first resilient part extending into the installation cavity. Similarly, the junction between the second clamping part and the second resilient part resides hinged within the second rotating groove, with the second resilient part also extending into the installation cavity.
wherein a first elastic reset component and a second elastic reset component are positioned within the installation cavity. Two opposing ends of the first elastic reset component are respectively attached to the quick-release base and the first clamping member, while two opposing ends of the second elastic reset component are respectively attached to the quick-release base and the second clamping member. Upon releasing the trigger, the first and second clamping members automatically revert to their original positions due to the presence of the first and second return springs.
wherein a third elastic reset component is positioned within the installation cavity, while two opposing ends of the third elastic reset component are connected to the trigger and the quick-release base, respectively. After releasing the trigger, the trigger itself automatically resets due to the third elastic reset component.
wherein a first electrical connector is positioned on a lateral side of the quick-release base adjacent to the clamping space, and a second electrical connector is positioned on the installation part. The first electrical connector and the second electrical connector are electrically interconnected.

An electronic device kit, wherein a protective case and the aforementioned detachable assembly are included. The protective case is equipped with a receiving cavity designed to house a mobile phone and is clamped within the clamping space formed between the first clamping part and the second clamping part. The synergy between the detachable assembly and the protective case allows the electronic device kit to be expanded with different photography accessories, fulfilling the diverse requirements of users when capturing images with their mobile phones.

The beneficial effects include:

Manipulation of the trigger controls the movable activation of the first clamping part on the quick-release base, thereby regulating the opening or clamping of the clamping space for rapid mounting and dismounting of the assembly onto the protective case. Based on the positioning of the installation part on the quick-release base, the protective case can be adapted to accommodate various photography accessories, catering to the diverse needs of users when capturing images with their mobile phones.

### BRIEF DESCRIPTION OF THE DRAWINGS

FIG. 1 is a diagram of a detachable assembly according to some aspects of the disclosure.

FIG. 2 is a diagram illustrating a sectional view of the detachable assembly according to some aspects of the disclosure.

FIG. 3 is a diagram of the detachable assembly with an installation part hidden according to some aspects of the disclosure.

FIG. 4 is a diagram of the detachable assembly with a quick-release base hidden according to some aspects of the disclosure.

FIG. 5 is a diagram of an electronic device kit according to some aspects of the disclosure.

### DETAILED DESCRIPTION

To clarify the objectives, technical solutions, and advantages of the present disclosure, further detailed descriptions are provided below in conjunction with the accompanying drawings and an exemplary embodiment. It should be noted that the specific embodiment presented herein is solely for the purpose of illustrating the present disclosure and is not meant to restrict its scope.

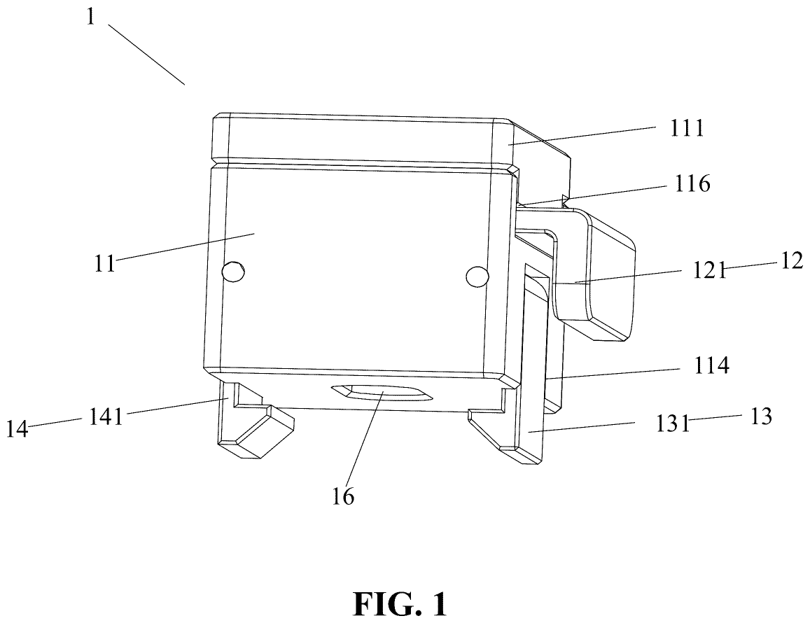

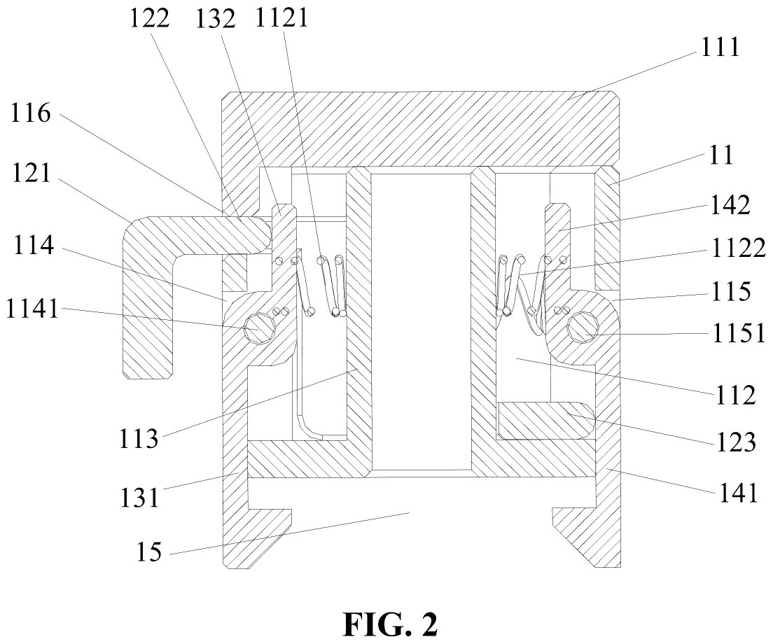

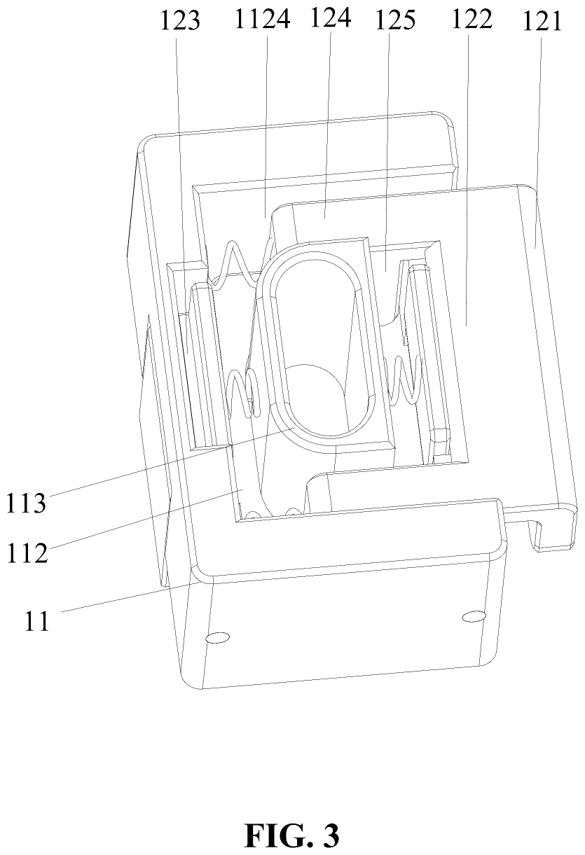

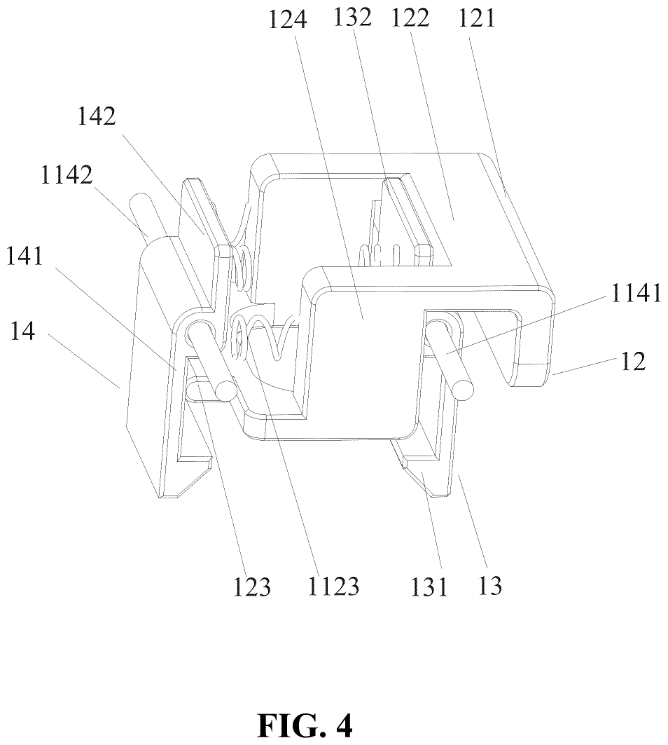

Referring to FIGS. 1-4, a detachable assembly includes a quick-release base 11, a trigger 12, a first clamping member 13, and a second clamping member 14. The first clamping member 13 and the second clamping member 14 are symmetrically arranged on opposite sides of the quick-release base 11. The first clamping member 13 includes a first clamping part 131 and a first resilient part 132, which are formed integrally. The first clamping part 131 protrudes beyond the perimeter of the quick-release base 11. Similarly, the second clamping member 14 includes a second clamping part 141 and a second resilient part 142, also formed integrally, with the second clamping part 141 protruding beyond the quick-release base 11. A clamping space 15 is defined between the first clamping part 131 and the second clamping part 141. The trigger 12 is movably mounted on the quick-release base 11. The junction between the first resilient part 132 and the first clamping part 131 is movably connected to the quick-release base 11, while one end of the trigger 12 abuts against the first resilient part 132. The other end of the trigger 12 extends beyond the quick-release base 11 to form a trigger part 121. In the detachable assembly 1, pressing the trigger part 121 causes the trigger 12 to actuate the movement of the first clamping member 13, thereby regulating the opening of the clamping space 15 to release a protective case or controlling the closing of the clamping space 15 to secure the protective case for rapid mounting and dismounting operations.

In some examples, an installation part 111 for detachable photographic accessories is located on one side of the quick-release base 11 opposite the clamping space 15.

Specifically, the trigger part 121 is shaped in an “L” configuration for ease of pressing.

In some examples, both the junction between the first resilient part 132 and the first clamping part 131, and the junction between the second resilient part 142 and the second clamping part 141, are hingedly attached to the quick-release base 11. The trigger 12 is drivingly connected to both the first resilient part 132 of the first clamping member 13 and the second clamping part 141 of the second clamping member 14. When the trigger part 121 is pressed, the trigger 12 simultaneously actuates the movement of both the first resilient part 132 and the second clamping part 141 to control the opening of the clamping space 15 for releasing the protective case or the closing of the clamping space 15 for clamping the protective case.

Furthermore, this embodiment includes an installation cavity 112 within the quick-release base 11. A limited post 113 is positioned within the installation cavity 112. A first elastic reset component 1121 and a second elastic reset component 1122 are also provided within the installation cavity 112, for example on opposite sides of the limited post 113. The two ends (opposite ends) of the first elastic reset component 1121 are respectively connected, by abutment, between the limited post 113 and the first clamping member 13. Similarly, the two ends (opposite ends) of the second elastic reset component 1122 are respectively connected, by abutment, between the limited post 113 and the second clamping member 14.

In some examples, the quick-release base 11 features a first rotating groove 114 and a second rotating groove 115, both extending into the installation cavity 112. A first pivot 1141 is disposed within the first rotating groove 114, and the joint between the first clamping part 131 and the first resilient part 132 is movably sleeved onto this pivot 1141, allowing the joint to be hingedly arranged within the first rotating groove 114. The first resilient part 132 extends into the installation cavity 112, with both ends of the first elastic reset component 1121 being respectively connected to a side of the first resilient part 132 adjacent to the installation cavity 112 and the limited post 113. A second pivot 1151 is disposed within the second rotating groove 115, and the joint between the second clamping part 141 and the second resilient part 142 is movably sleeved onto this pivot 1151, allowing the joint to be hingedly arranged within the second rotating groove 115. The second resilient part 142 extends into the installation cavity 112, with both ends of the second elastic reset component 1122 being respectively connected to a side of the second resilient part 142 adjacent to the installation cavity 112 and the limited post 113. Upon releasing the trigger part 121, the first clamping member 13 and the second clamping member 14 return to their original positions under the action (e.g., extension) of the first elastic reset component 1121 and the second elastic reset component 1122, respectively.

In some examples, the quick-release base 11 features a pressing hole 116 leading into the installation cavity 112 on one side, allowing one end of the trigger 12 to pass through and form a first resisting part 122 against one side of the first resilient part 132 away from the installation cavity 112. A second resisting part 123, fixed on the first resisting part 122, resists against the second clamping part 141 near the installation cavity 122. Specifically, upon pressing the trigger part 121, the pressing hole 116 facilitates the movement of the trigger. The first resisting part 122 exerts pressure against the outer side of the first resilient part 132 of the first clamping member 13, which faces away from the installation cavity 112. This causes the first clamping member 13 to rotate, prompting the first clamping part 131 to move outward. Simultaneously, the second resisting part 123 applies pressure to the inner side of the second clamping part 141 of the second clamping member 14, which faces towards the installation cavity 112. Consequently, the second clamping member 14 rotates, and the second clamping part 141 moves outward, enabling swift control over the opening and closing of the clamping space 15.

In some examples, one end of the first resisting part 122 is fixedly equipped with a connecting part 124, which is securely attached to the second resisting part 123. Additionally, a third elastic reset component 1123 is positioned within the installation cavity 112, with its ends connected to the connecting part 124 and a side surface of the installation cavity 112, respectively. These connections may be abutting connections. In one example, the connecting part is shaped like an “L,” allowing the first resisting part 122 and the second resisting part 123, connected by the connecting part, to abut against the side of the first resilient part 132 away from the installation cavity 112 and the side of the second clamping part 141 near the installation cavity 112.

In some examples, the first elastic reset component 1121, the second elastic reset component 1122, and the third elastic reset component 1123 may include structures such as tension springs, torsion springs, leaf springs, and similar elastic components.

In some examples, a guiding and limiting channel 1124 is formed between the limited post 113 and a side surface of the installation cavity 112, designed to limit and guide the movement of the connecting part 124. The connecting part 124 is movably disposed within this guiding and limiting channel 1124, ensuring that its movement direction and distance are controlled by the channel 1124.

Furthermore, this embodiment incorporates two connecting parts 124 and two parallel guiding and limiting channels 1124. The two connecting parts 124 are movably disposed within their respective guiding and limiting channels 1124. One end of each connecting part 124 is fixedly connected to the first resisting part 122, while the other end is fixedly connected to the second resisting part 123. A movable limiting hole 125 or opening is formed among the first resisting part 122, the second resisting part 123, and the two connecting parts 124, with the limited post 113 passing through this hole. When the trigger part 121 is pressed, causing the trigger 12 to move, the limited post 113 moves relative to the limiting hole 125, fulfilling both guiding and limiting functions.

In some examples, a first electrical connector 16 is positioned on a lateral side of the quick-release base 11 adjacent to the clamping space 15, and a second electrical connector is positioned on the installation part 111. The photographic accessories and the installation part 111 configured as a one-piece molding. and the second electrical connector is printed circuit board (PCB) of the photographic accessories. The first electrical connector and the second electrical connector are electrically interconnected. When the detachable assembly 1 is installed on the protective case, the first electrical connector establishes an electrical connection with a corresponding electrical connector on the protective case. Additionally, the second electrical connector establishes an electrical connection with a photographic accessory mounted on the installation part 111. This setup facilitates power supply coordination or expansion coordination between the photographic accessory and the mobile phone case.

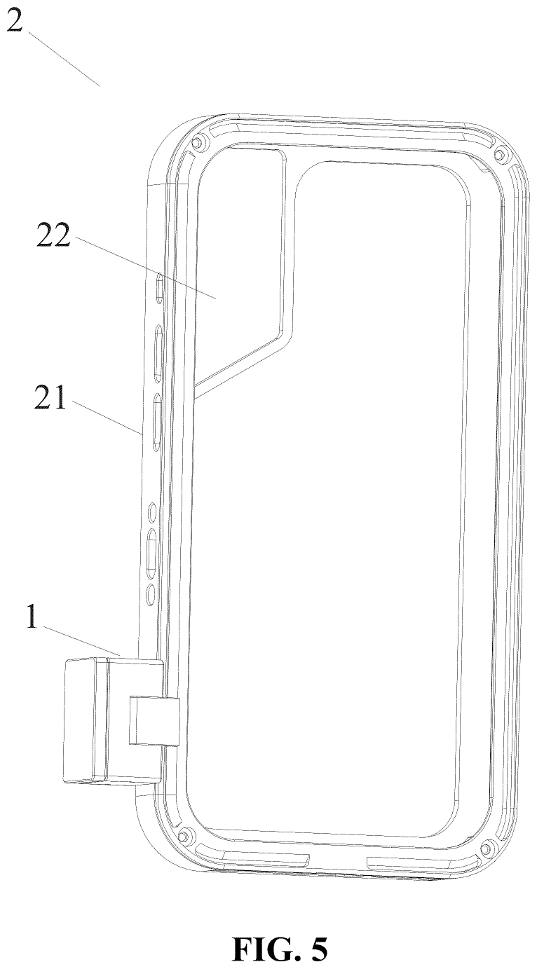

Referring to FIGS. 1-5; this embodiment also presents an electronic device kit including a protective case 21 and a detachable assembly 1. The protective case 21 is equipped with a receiving cavity 22 designed to house a mobile phone and is clamped within the clamping space 15 formed between the first clamping part 131 and the second clamping part 141.

The above description discloses an exemplary embodiment of the present disclosure and is not intended to limit its scope. Any modifications, equivalent substitutions, and improvements made within the spirit and principles of this utility model should be considered within the scope of its protection.

What is claimed is:

1. A detachable assembly, comprising:
a quick-release base, a trigger, a first clamping member, and a second clamping member;
wherein the first clamping member and the second clamping member are respectively provided on opposite sides of the quick-release base, and a portion of the first clamping member and a portion of the second clamping member respectively protrude beyond the quick-release base to form a clamping space between the first clamping member and second clamping member;
wherein the first clamping member is movably connected to the quick-release base; and
wherein the trigger is movable on the quick-release base, a first end of the trigger abuts against the first clamping member, and a second end of the trigger protrudes outside of the quick-release base as a trigger part.

2. The detachable assembly according to claim 1, further comprising an installation part configured to mount photographic accessories, the installation part located on one side of the quick-release base opposite the clamping space.

3. The detachable assembly according to claim 1, wherein the first clamping member and the second clamping member are both hinged to the quick-release base, and the trigger abuts against both the first clamping member and the second clamping member.

4. The detachable assembly according to claim 3, wherein the first clamping member comprises a first clamping part and a first resilient part, and the second clamping member comprises a second clamping part and a second resilient part;
wherein a junction between the first clamping part and the first resilient part is hinged to the quick-release base, and a junction between the second clamping part and the second resilient part is hinged to the quick-release base, the clamping space is formed between the first clamping part and the second clamping part;
wherein an installation cavity is positioned within the quick-release base;
wherein the quick-release base comprises a pressing hole leading into the installation cavity on one side, allowing one end of the trigger to pass through and form a first resisting part against one side of the first resilient part away from the installation cavity; and
wherein a second resisting part formed by another end of the trigger, fixed on the first resisting part, resists against the second clamping part near the installation cavity.

5. The detachable assembly according to claim 4, further comprising a limited post positioned within the installation cavity;
wherein a connecting part is disposed between the first resisting part and the second resisting part, forming a movable limiting hole among the first resisting part, the second resisting part, and the connecting part; and
wherein the limited post passes through the movable limiting hole.

6. The detachable assembly according to claim 5, wherein a guiding and limiting channel is formed between the limited post and a lateral side of the installation cavity, to constrain and direct the connecting part to move; and
wherein the connecting part is movably accommodated within the guiding and limiting channel.

7. The detachable assembly according to claim 4, wherein the quick-release base is equipped with a first rotating groove and a second rotating groove, extending into the installation cavity;
wherein the junction between the first clamping part and the first resilient part resides hinged within the first rotating groove, with the first resilient part extending into the installation cavity; and
wherein the junction between the second clamping part and the second resilient part resides hinged within the second rotating groove, with the second resilient part also extending into the installation cavity.

8. The detachable assembly according to claim 4, further comprising a first elastic reset component and a second elastic reset component that are positioned within the installation cavity; and
wherein two opposing ends of the first elastic reset component are respectively connected to the quick-release base and the first clamping member, and two opposing ends of the second elastic reset component are respectively connected to the quick-release base and the second clamping member.

9. The detachable assembly according to claim 4, further comprising a third elastic reset component positioned within the installation cavity, wherein two opposing ends of the third elastic reset component are connected to the trigger and the quick-release base, respectively.

10. The detachable assembly according to claim 2, further comprising a first electrical connector positioned on a lateral side of the quick-release base adjacent to the clamping space.

11. An electronic device kit, comprising a protective case and the detachable assembly according to claim 1,
wherein the protective case is equipped with a receiving cavity designed to house a mobile phone and is clamped within the clamping space formed between the first clamping part and the second clamping part.
